(19) United States
(12) Patent Application Publication
(10) Pub. No.: US 2011/0270772 A1
(43) Pub. Date: Nov. 3, 2011

(54) Method of Leasing a Vehicle

(76) Inventors: David R. Hall, Provo, UT (US); Stephen Hall, Sandy, UT (US)

(21) Appl. No.: 12/771,124

(22) Filed: Apr. 30, 2010

(51) Int. Cl. G06Q 50/00; G06Q 10/00; G06Q 30/00

(52) U.S. Cl. 705/305; 705/307

(57) ABSTRACT

In one aspect of the present invention, a method of leasing a vehicle comprises the steps of providing by a lessor a vehicle that incurs ongoing operating costs and leasing the vehicle to a lessee, wherein the ongoing operating costs are included in a recurring lease payment paid by the lessee to the lessor.

### BACKGROUND OF THE INVENTION

The invention relates to the practice of leasing vehicles from one party to another. As the cost of transportation increases and concerns about the environment grow, it is desirable to provide a method of leasing vehicles that minimizes inefficiencies in the production, use, and maintenance of motor vehicles. Efforts to improve such efficiency are disclosed in the art.

U.S. Patent Application No. 20060265235 to Schuchardt which is herein incorporated for all that it contains discloses An improved lease management system is disclosed herein for use by fleet managers to manage customer vehicle leases for a variety of management issues that arise throughout the lifecycle of a lease. According to one aspect, the system comprises a system for management of a plurality of vehicle leases, the system comprising: (1) at least one user computer; (2) a memory storing a database, the database being configured to store vehicle lease data for each of a plurality of vehicle leases; and (3) a server in communication with the user computer and the memory, the server being configured to execute a lease management software program, the lease management software program being configured to provide lease management functionality for each of said vehicle leases throughout a vehicle lease lifecycle via a plurality of interrelated graphical user interfaces (GUIs), the lease management functionality including a plurality of user selectable maintenance actions for an activated one of said customer vehicle leases, and wherein the lease management software program is further configured to update the stored vehicle lease data in the database in response to a user selection of at least one of said plurality of selectable maintenance actions.

U.S. Patent Application No. 20080201160 to Chang which is herein incorporated for all that it contains discloses a method for managing car lease using a car-use electronic device and a mobile device, comprising steps of: picking up a car data from a data base for matching so as to provide a first data comprising a car password and a second data comprising a user password when an information center receives a renting request, wherein the car password and the user password are matched; transmitting the first data to the mobile device of a user and the second data to a controller on a car; and authorizing the user to star [sic] the car if the controller verifies that the car password and the user password are matched after the user transmits the car password from the mobile device to the controller.

U.S. Pat. No. 7,610,209 to Stanton which is herein incorporated for all that it contains discloses Methods of the present invention are designed to offer insurance to lessees of vehicles to cover up front, out-of-pocket lease expenses in the event of a total loss, e.g., theft, and preferably include steps performed by a vehicle leasing dealer as well as steps performed by one or more participating insurers. The steps are preferably performed with the aid of computing devices which are in communication. When the lease is prepared, the relevant information about the lease and the lessee is submitted by the lease dealer to the participating insurers. The insurers determine the cost of supplemental insurance based on this information and, if the cost is acceptable, offer insurance coverage to the lessee.

U.S. Pat. No. 6,173,941 to Johnston which is herein incorporated for all that it contains discloses A mobile vehicle service trailer provides a portable maintenance facility for motor vehicles (passenger cars, pickup trucks and sport utility vehicles, etc.) without need to transport the vehicle to a maintenance facility at a fixed location. The present trailer has rearwardly disposed wheels and laterally extendible ramps, enabling the trailer to be positioned laterally at the front or rear of the vehicle needing service and the vehicle to be positioned laterally across the trailer. This configuration provides for ease of loading and unloading the vehicle to and from the trailer in cramped parking situations, such as parking lots and garages, etc. The rear wheels of the trailer are pivotally mounted, allowing the trailer body to be lowered to the underlying surface for placement of a vehicle thereon. A specially formed trailer hitch may be provided for the towing vehicle, allowing the hitch ball to be lowered to the underlying surface to lower the trailer tongue without disconnecting the trailer from the towing vehicle. Corner jacks are provided for raising and lowering the trailer body as desired. A forward and a rearward hydraulically powered lift hoist are provided on the trailer body, for raising the vehicle for access to the underside thereof for maintenance operations (oil changes, etc.). The present trailer also includes a hydraulic power supply for operating the corner jacks, vehicle hoists, and for raising and lowering the ramps as desired.

### BRIEF SUMMARY OF THE INVENTION

In one aspect of the present invention, a method of leasing a vehicle comprises the steps of providing by a lessor a vehicle that incurs ongoing operating costs, leasing the vehicle to a lessee, wherein the ongoing operating costs are included in a recurring lease payment paid by the lessee to the lessor.

In some embodiments, the ongoing operating costs may include liability insurance, collision insurance, comprehensive insurance, or other insurance; cost of energy used by the vehicle such as gasoline, diesel oil, electricity, or other fuels; maintenance costs such as oil changes, tire rotations, fuel and air filter changes, or other maintenance items; mechanical repairs such as timing belts, brake resurfacing, or other items; incidental damage repair, collision repair, and governmental fees such as taxes, licensing, registration, or other fees.

In some embodiments, the method comprises the step of the lessor disabling the vehicle with a remote disable function. The lessor may disable the car if lease payments are not made or if repairs and maintenance items are not attended to. The vehicle may also comprise a GPS system, wherein the lessor can ascertain the location of the vehicle at all times to enable maintenance, repair, or repossession by the lessor.

In some embodiments, the method includes the step of the lessor performing all maintenance and repair items including routine maintenance, mechanical repairs, collision repair, and other damage repair.

In some embodiments, the vehicle may comprise two steerable front wheels and a single rear wheel. The vehicle may comprise a deformation resistant roll cage disposed about an enclosed passenger compartment. The enclosed passenger compartment may comprise a seat that places an operator in a generally recumbent position. The vehicle may comprise a center of gravity disposed forward of a midpoint of a wheelbase of the vehicle and below a plane formed by the axes of rotation of the wheels. The vehicle may also comprise a trailing arm that connects the rear wheel with a frame of the vehicle. The vehicle may comprise a constantly variable transmission.

### BRIEF DESCRIPTION OF THE DRAWINGS

FIG. 1 is a perspective view of an embodiment of a leased vehicle.

FIG. 2 is an orthogonal view of another embodiment of a leased vehicle.

FIG. 3a is a perspective view of an embodiment of a tracking system.

FIG. 3b is a perspective view of another embodiment of a leased vehicle.

FIG. 4 is a perspective view of an embodiment of a mobile repair shop.

FIG. 5 is a perspective view of another embodiment of a repair shop.

FIG. 6 is a perspective view of an embodiment of a lease payment invoice.

FIG. 7 is a perspective view of an embodiment of a leasing interface.

FIG. 8 is a perspective view of an embodiment of a gas station.

FIG. 9 is a perspective view of an embodiment of a dashboard.

FIG. 10 is an orthogonal view of an embodiment of a bulldozer.

FIG. 11 is a perspective view of an embodiment of an excavator.

FIG. 12 is a perspective view of an embodiment of a utility cart.

FIG. 13 is an orthogonal view of an embodiment of a motorcycle.

FIG. 14 is a perspective view of an embodiment of a utility van.

FIG. 15 is a perspective view of an embodiment of a semi truck.

FIG. 16 is an embodiment of a method of leasing a vehicle.

### DETAILED DESCRIPTION OF THE INVENTION AND THE PREFERRED EMBODIMENT

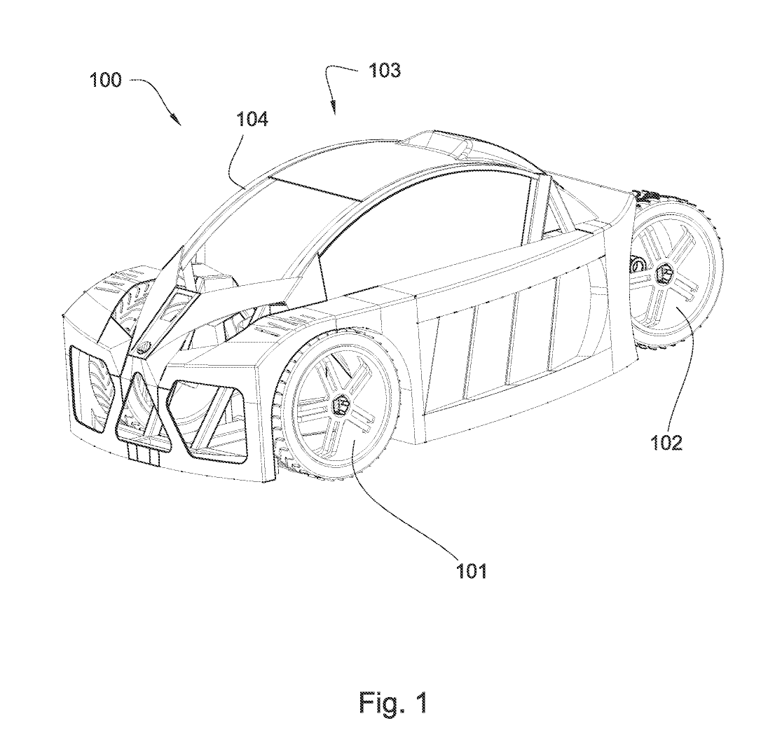

Referring now to the figures, FIG. 1 discloses an embodiment of a leased vehicle 100. In this embodiment, the leased vehicle 100 comprises two front wheels 101 and one rear wheel 102, an enclosed passenger compartment 103, and a roll cage 104.

The vehicle 100 may comprise significant ongoing operating costs including but not limited to fuel or energy consumption, operator insurance including liability, collision, and comprehensive coverage, routine maintenance costs, mechanical repairs, collision repair, and other damage repair.

In this embodiment, the vehicle 100 is leased by a lessor to a lessee. The lessee may be responsible for a regular payment to the lessor for the use of the vehicle. In addition to the payment for the use of the vehicle, the previously mentioned significant ongoing operating costs may be substantially included in the lease payment. The vehicle 100 may comprise a useful operating lifetime, and the vehicle may be leased to one or more lessees during the useful lifetime, after which the vehicle may be dismantled and recycled by the lessor.

An operator of a motor vehicle is frequently required to purchase insurance. Insurance may cover financial liability resulting from damages to property or health incurred by the motor vehicle, damage to the motor vehicle resulting from traffic accidents, and incidental damages to the motor vehicle. Generally, insurance is purchased by the operator of the motor vehicle. In the embodiment of vehicle 100, the lessor may purchase insurance covering the operator of the vehicle for financial liability, collision repair, other coverage, or combinations thereof. The premiums paid by the lessor may be included in the recurring lease payment.

Motor vehicles typically require frequent preventive maintenance and periodic repair. Maintenance items may include engine oil changes, oil filter replacement, air filter replacement, spark plug replacement, tire rotation and inflation, engine timing and accessory belt replacement, and other items. Periodic repair items may include replacing failed mechanical or cosmetic components, or repairing the vehicle after a collision.

In the prior art, these repair and maintenance items frequently require specialized skills that vary between vehicles produced by different manufacturers, and require dealers and service shops to keep a wide variety of parts and supplies in inventory. This increases the cost of maintaining and repairing the vehicle, and reduces profits for the dealers and service shops that sell and maintain the vehicles. In the embodiment of FIG. 1, the lessor leases vehicles of a certain type, for example vehicle 100. Parts and components may be interchangeable between different vehicles of the same type, allowing the lessor to keep a relatively small inventory of replacement parts and supplies. This may significantly reduce the cost of maintaining and repairing motor vehicles of the same type as vehicle 100. The lessor may perform maintenance and repair items on the vehicle 100 and include the cost of those items in the recurring lease payment.

Motor vehicles may also be subject to governmental fees such as sales tax and registration. In some embodiments, the lessor may pay such fees and include them in the recurring lease payment.

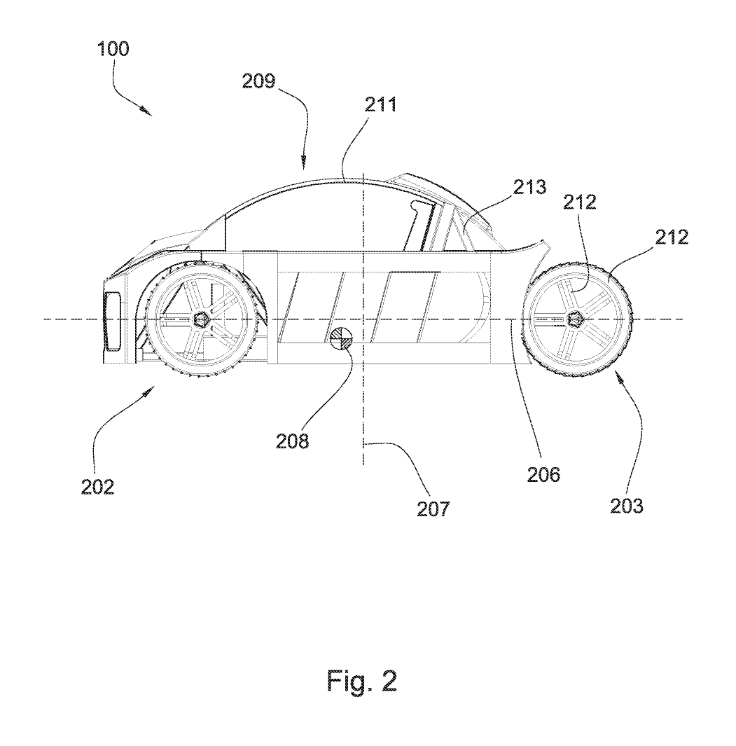

FIG. 2 discloses another embodiment of a motor vehicle 100. In this embodiment, motor vehicle 100 comprises two steerable front wheels 202 and a single rear wheel 203. A single rear wheel 203 may reduce the weight, complexity, and manufacturing cost of the vehicle 100, while retaining acceptable or optimal dynamic stability. The front and rear wheels 202 and 203 may comprise interchangeable rims 204 and tires 205, such that tire rotations can be performed between the front 202 and rear 203 of the vehicle 100 or between front sides of the vehicle. Rims 204 and tires 205 may be substantially the same size for any vehicle of the same type as vehicle 100, allowing wheels and tires to be rotated between vehicles to prolong tire tread life. Wheel and tire assemblies comprising different tread types may be rotated between vehicles as needed. Such tread types could include winter tread tires, wet weather tread tire, dry pavement tires, or high performance tires.

In this embodiment, the motor vehicle 100 comprises an internal combustion engine with a volumetric displacement between 500 and 2000 cubic centimeters. The engine may comprise multiple cylinders in an inline, flat, or “V” arrangement and may operate in a four-stroke cycle. The engine may burn gasoline, alcohol, or combinations thereof. In this embodiment, the internal combustion engine is connected to a constantly variable transmission (CVT) to allow the engine to operate at maximum efficiency. The CVT comprises an output shaft that transmits torque to the rear wheel through a drive system such as a shaft, chain and sprockets, or belt and pulleys. In other embodiments, the engine may be connected to a transmission with discrete gear ratios using helical gears or planetary gears.

In other embodiments, the engine may be a two-stroke cycle engine, a compression ignition engine, a rotary engine, a turbine engine, or other combustion engine. The engine may consume gasoline, petroleum Diesel, bio Diesel, ethanol, methanol, kerosene, or other mineral or organic fuels. In some embodiments, the lessor may provide the required fuel to the motor vehicle lessee. The cost of the fuel may be included in the recurring lease payment. In some embodiments, the vehicle may comprise a hybrid drive system comprising an internal combustion engine of any of the foregoing type, an energy accumulator, and an energy dissipater. The accumulator may comprise an electrical battery or a hydraulic or pneumatic pressure vessel, and the energy dissipater may comprise an electric motor, or a pneumatic or hydraulic motor. In another embodiment, the vehicle 100 comprises an electric drive with a battery and electric motor. The lessor may purchase electrical power necessary to charge the battery, and the cost of the electrical power may be included in the recurring lease payment. Other possible propulsion systems, such as a hydrogen or hydrocarbon fuel cell, are within the scope of the invention.

The motor vehicle 100 comprises a wheelbase 206 measured between the axis of rotation of the front wheels 202 and rear wheel 203. The wheelbase comprises a midpoint 207 located halfway between the front wheel axis and rear wheel axis. A center of gravity 208 may be disposed on front of and below the midpoint 207 of the wheelbase 206. This location for the center of gravity may enhance dynamic stability of the vehicle during rapid maneuvers, preventing loss of control or rollover. Other methods may be used to enhance stability such as electronic traction control, throttle limiters, or combinations thereof.

The motor vehicle 100 may comprise an enclosed passenger compartment 209. An operator may sit in a seat in a generally recumbent position. The enclosed passenger compartment may comprise amenities such as a heater, air conditioner, audio system, GPS, or other convenience or entertainment features. A deformation resistant roll cage 211 may be disposed about the passenger compartment 209. In the event of a collision or rollover, the roll cage 211 may prevent injury to the operator. The roll cage may be constructed from steel, aluminum alloy, composite materials such as fiberglass or carbon fiber, other materials, or combinations thereof.

The rear wheel 203 may be connected to a frame 212 of the vehicle by a trailing arm type suspension. The vehicle may comprise a structural frame separate from an exterior body of the car, or may be of unified construction wherein the body and frame together comprise the structure of the vehicle.

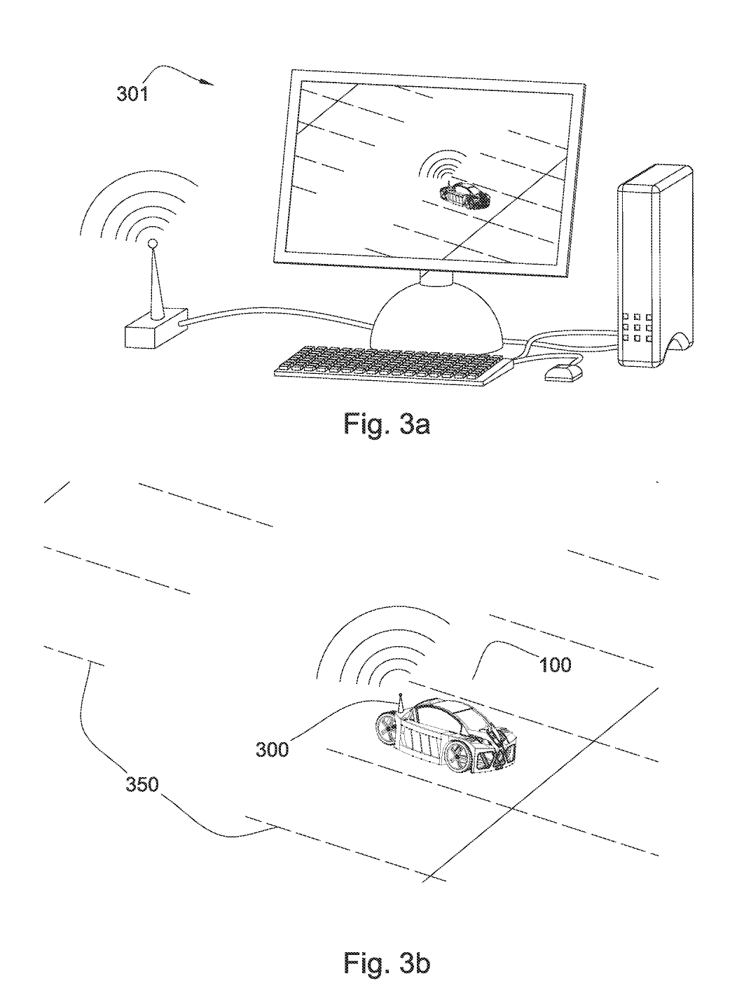

FIGS. 3a and 3b disclose the leased motor vehicle 100 equipped with a global positioning system (GPS) 300. A computer terminal 301 may be linked to the GPS, and may disclose the location of vehicle 100 at any time. The lessor may view the location of the vehicle using the computer terminal 301. In some embodiments, the leased motor vehicle 100 comprises a remote disable function that allows the lessor to prevent the lessee from starting or driving the vehicle if certain conditions are not met. For example, the lessor may choose to disable the vehicle if lease payments are outstanding, if the vehicle requires preventive maintenance or repair, if mileage limits are exceeded, or if the motor vehicle is misused. Also, the vehicle may be disabled by the lessor if the lessee reports the vehicle stolen. The remote disable function may operate only when the vehicle is safely parked, such as in a parking stall 350 of a parking lot, to prevent inadvertent disabling if the vehicle is operating on a roadway or parked in a remote location far from civilization. In some embodiments, the lessee may have access to the GPS location and disable function of the vehicle.

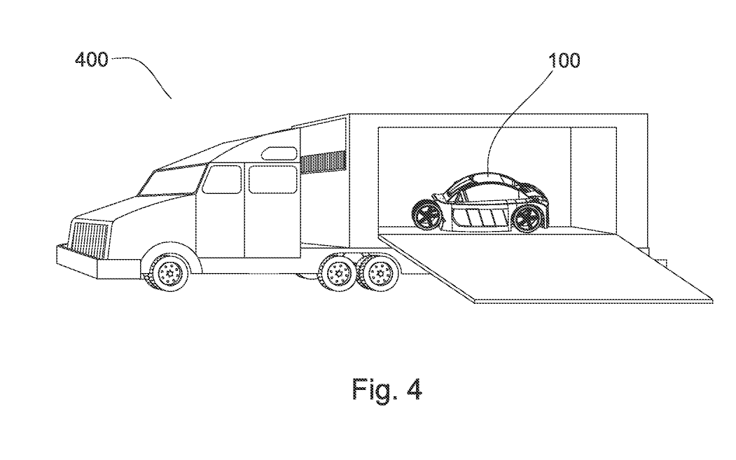

FIG. 4 discloses an embodiment of a mobile repair shop 400. In this embodiment, when the leased motor vehicle 100 may require repair or maintenance the mobile repair shop may go to the vehicle. The mobile repair shop 400 may be operated by the lessor, and may be brought to a location of the leased motor vehicle 100 at the request of the lessee or lessor. The mobile repair shop may service only vehicles of the same type as leased motor vehicle 100, thus minimizing the number of different parts and products that must be kept in inventory. Preferably, the mobile repair shop goes to the home or work place of the lessee and routine maintenance of the vehicle is as transparent to the lessee as possible.

In some cases, the vehicle's repair may be significant. In these situations, the lessor or lessee may opt to replace the leased vehicle with another vehicle to avoid inconveniencing the lessee, especially when the vehicle's fleet comprises vehicles of the same make and model. In some embodiments, a replacement vehicle is regularly stored in the mobile repair shops 400 just in case.

The vehicle's routine maintenance may include upgrading the vehicles with the latest parts and diagnostic software. Some parts, like tires, that should be rotated periodically may be rotated not only different positions on the same car, but also throughout a fleet of vehicles. In some cases, a computer tracks each vehicle and part, schedules their replacement and/or maintenance, and monitors their operating conditions. For example, the computer may remotely diagnose that a tire is low, a battery's life is nearly over, the wrong type of gas was pumped into the tank, an axle is loose, or any number of potential operating issues. These diagnostics may inform a repair crew of the vehicle's condition prior to the repair shop's arrival to save time.

A lessee's operating profile may be recorded remotely through a computing system. The lessee's weight, average passenger number, luggage weight and size, average speed, braking habits, and other lessee behaviors. This profile may be considered when offering the lessee upgraded vehicles, negotiating further business deals, and when scheduling maintenance.

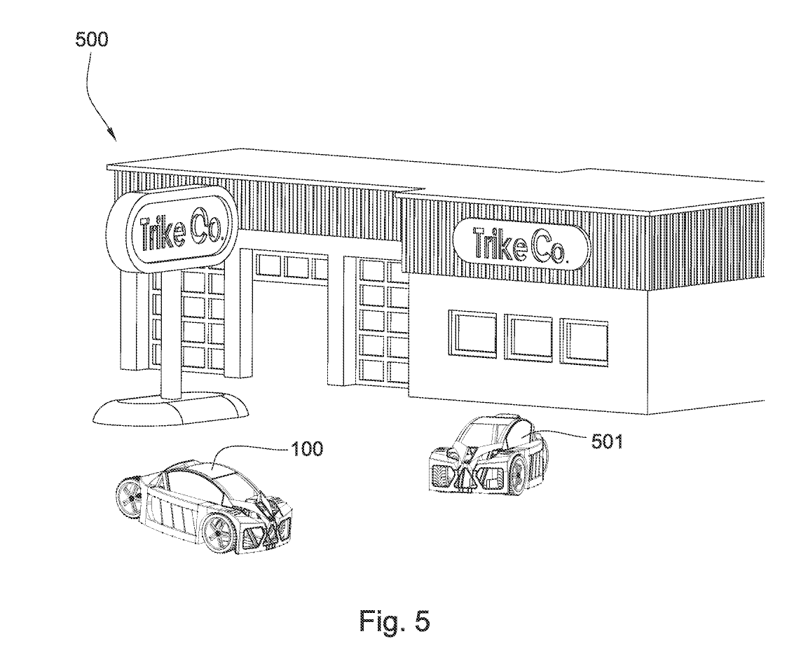

FIG. 5 discloses an embodiment of a repair shop 500 operated by the lessor. In this embodiment, a replacement vehicle 501 may be available for the lessee to use while the leased vehicle 100 undergoes repair, maintenance, or other service operations. In some embodiments, the replacement vehicle is used only while the repair work is being done, or in other embodiments, the replacement vehicle becomes the lessee's new vehicle under the lease agreement.

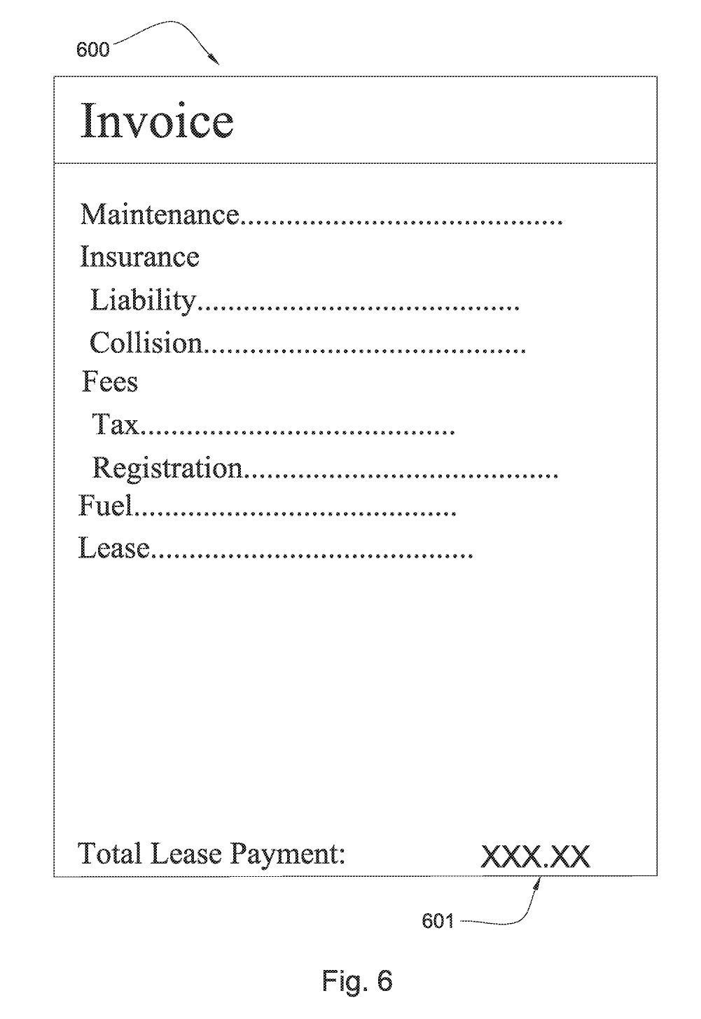

FIG. 6 discloses an embodiment of a lease payment invoice 600. The lease payment invoice may disclose part or all of the recurring operating costs associated with operating the vehicle, including maintenance or repair, insurance, governmental fees, fuel costs, and lease payment. The invoice may show a total payment 601 due the lessor. In this embodiment, the lease payment invoice is remitted from the lessor to the lessee.

In some embodiments, the ongoing operating costs may be averaged over the lease period of a vehicle, averaged over a fleet of leased vehicles, or both, so that the recurring lease payments comprise the same total amount over the period of the lease. In some embodiments, the additional costs may be averaged over several payments, several years or the remainder of the lease. Such additional costs may include collision damage, misuse damages, car neglect damages, etc.

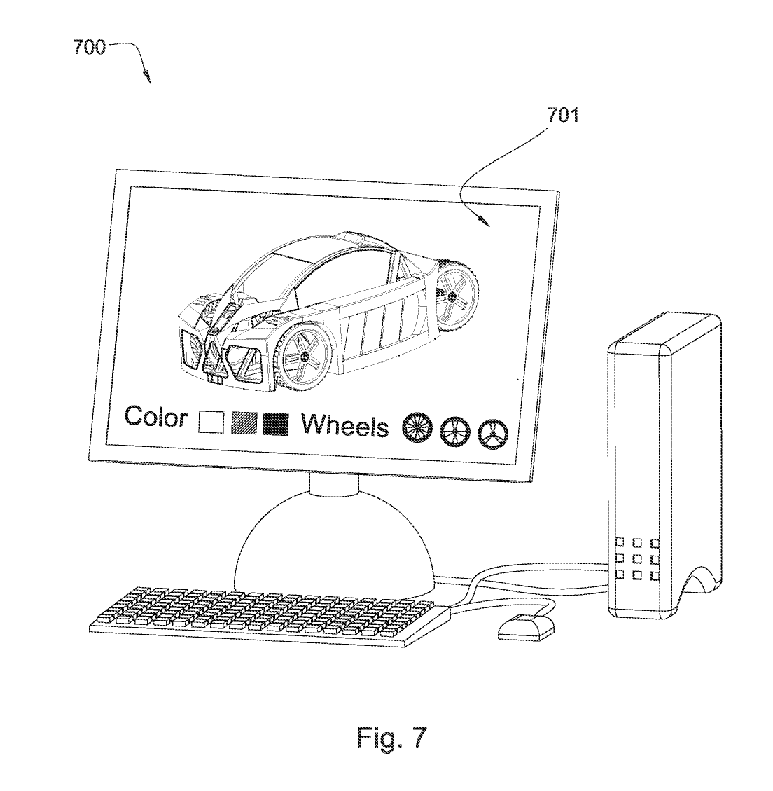

FIG. 7 discloses a computer terminal 700 showing an online vehicle configurator 701. A potential lessee may access the vehicle configurator through the internet or at a computer terminal operated by the lessor. In some embodiments, the computer terminal may be operated by the lessor and may be located in a showroom. In other embodiments, the lessee may access the vehicle configurator through the internet and may choose features such as exterior color, style of wheels, body design, and other options, order the vehicle online, and the vehicle may then be delivered to the lessee by the lessor.

The parts of the lessee's vehicle may be in storage prior to the lessee's configuration request. After the request is processed, the lessor may assemble the vehicle or modify a preassembled vehicle. In some embodiments, the lessor may deliver the vehicle to the lessee.

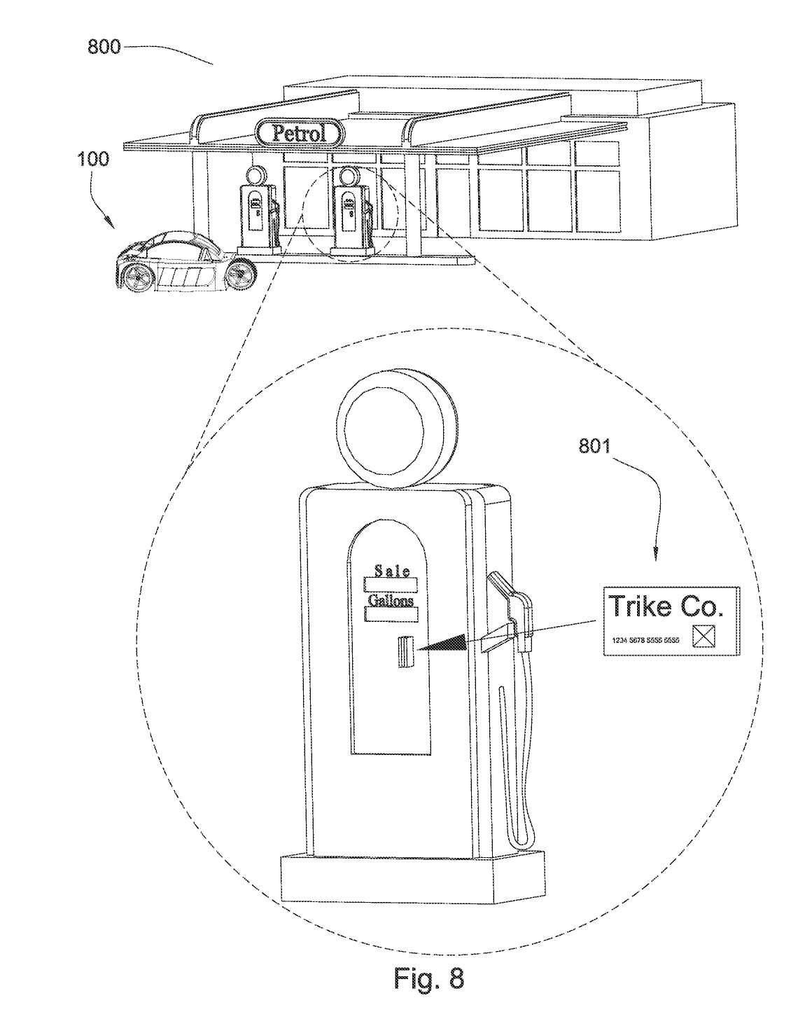

FIG. 8 discloses a fueling station 800 where a lessee may fuel a leased vehicle 100. A lessor may provide the lessee with a credit card 801 or other payment instrument, billed to the lessor, and the cost of the fuel purchased at the fueling station may be included in the recurring lease payment. In some embodiments, the payment instrument may be in remote communication with a remote computer or a wireless system located on the vehicle. Thus, the payment instrument may know the vehicle's tank size, and or empty space in the vehicle and prevent the lessee from abusing the system by trying to incur fuel costs for lawn mowers, boats, or other vehicles to the lessor. In some embodiments, fueling other machines or buying snacks at the station's convenience store may be permissible since the cost is allocated back to the lessee. These costs may be charged at monthly payments or averaged over a number of payment periods.

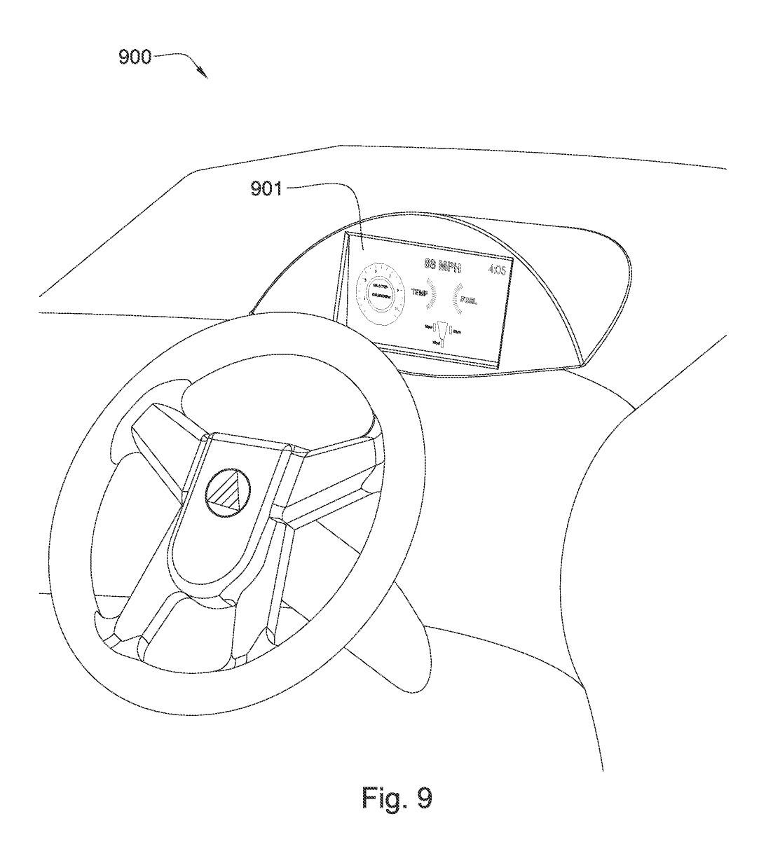

FIG. 9 discloses a dashboard 900 that may be disposed in a passenger compartment. In this embodiment, the dashboard comprises an instrument panel 901 that may display important information to the operator including road speed, engine speed, fuel level, oil temperature and level, coolant temperature, tire pressure, total mileage, trip mileage, local time, or other operating parameters. The instrument panel may also display required maintenance times and display warnings when safe operating parameters are exceeded. For example, it may display a mileage remaining until the next oil change, tire rotation, or other maintenance item, and may show warnings if maintenance items are not performed, the coolant or oil temperature is too high, fuel or oil level is low, seatbelts are not fastened, or if any other exception to safe operating procedure is detected.

In some embodiments, the instrument panel 901 may comprise an LCD or LED display. The display may be touch sensitive to allow operator interaction with the display. The operator may choose different display styles, change the list of parameters that are constantly displayed, change the brightness of the display, or use the display to control an interior audio system, a climate control system, a navigation system, or any other system in the vehicle. Touch sensitivity may be locked out for some or all of the functions when the vehicle is in motion to prevent operator distraction.

In some embodiments, the leased vehicle may comprise recreational vehicles or industrial equipment.

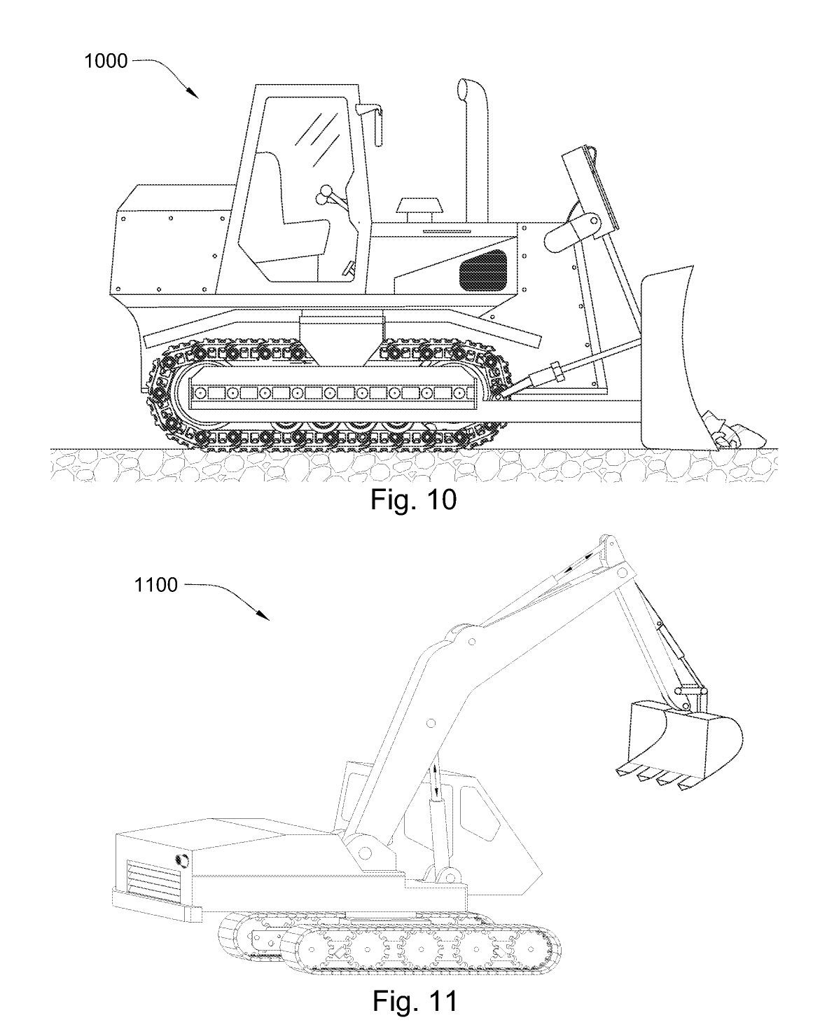

FIG. 10 discloses another embodiment of a leased vehicle. In this embodiment, leased vehicle 1000 comprises a bulldozer.

FIG. 11 discloses an embodiment of a leased vehicle comprising an excavator 1100.

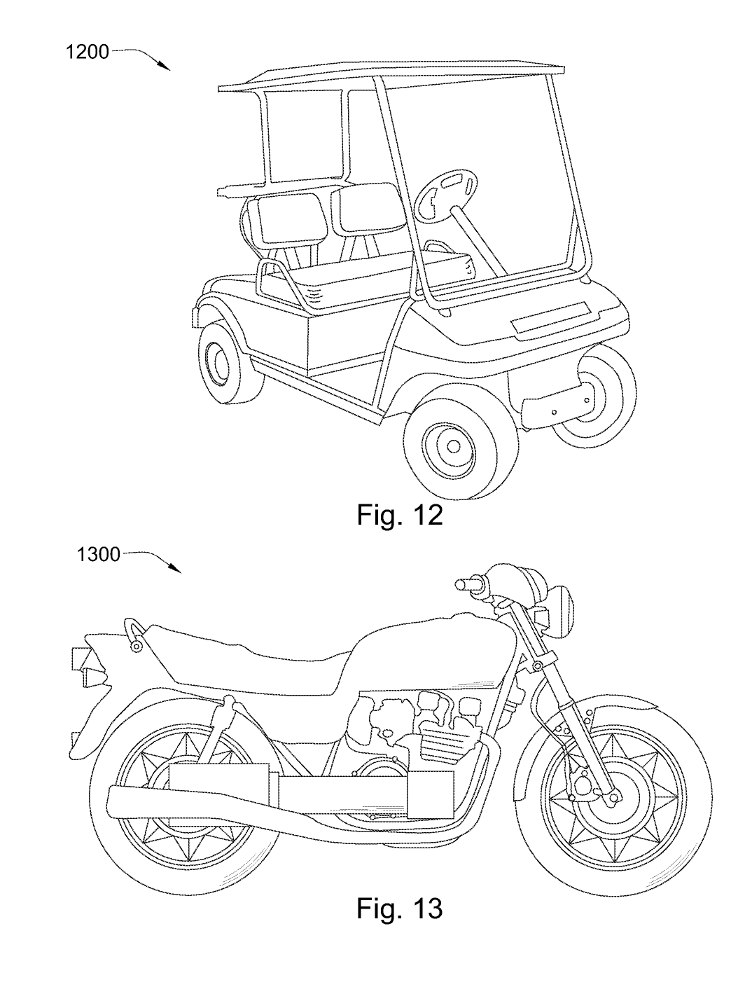

FIG. 12 discloses an embodiment of a leased golf cart or utility cart 1200.

FIG. 13 discloses an embodiment of a leased motorcycle 1300.

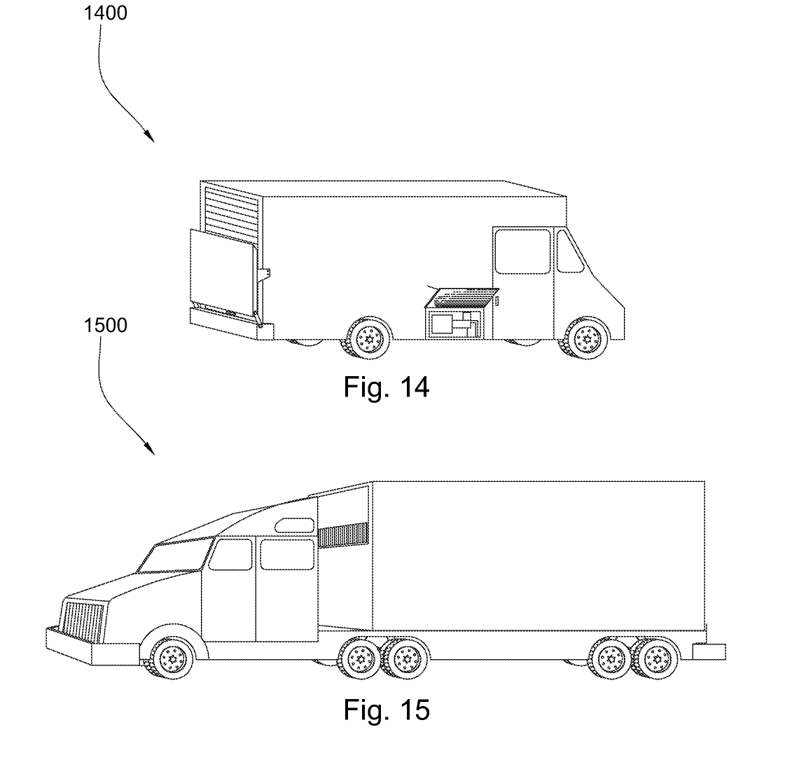

FIG. 14 discloses an embodiment of a leased delivery van 1400.

FIG. 15 discloses an embodiment of a leased semi truck 1500.

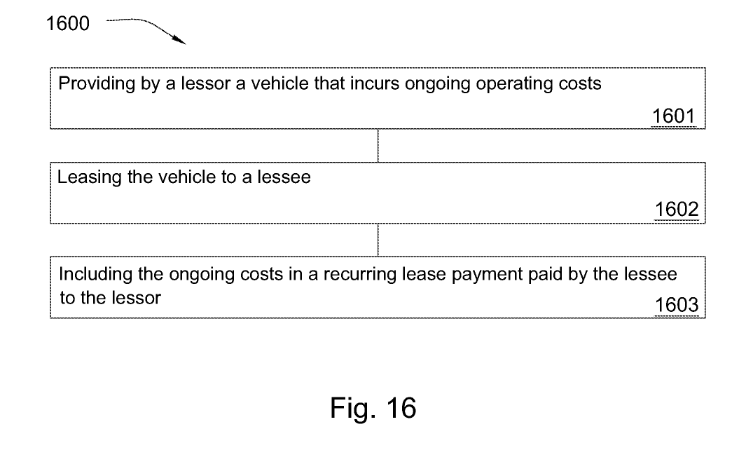

FIG. 16 discloses a method of leasing a vehicle 1600 comprising the steps of providing 1601 by a lessor a vehicle that incurs ongoing operating costs, leasing 1602 the vehicle to a lessee, including 1603 the ongoing operating costs in a recurring lease payment paid by the lessee to the lessor.

Whereas the present invention has been described in particular relation to the drawings attached hereto, it should be understood that other and further modifications apart from those shown or suggested herein, may be made within the scope and spirit of the present invention.

What is claimed is:

1. A method of leasing a vehicle, comprising the steps of:
providing by a lessor a vehicle that incurs ongoing operating costs;
leasing the vehicle to a lessee;
wherein the ongoing operating costs are included in a recurring lease payment paid by the lessee to a lessor.

2. The method of claim 1 wherein the operating costs include routine maintenance.

3. The method of claim 1, wherein the operating costs include mechanical repairs.

4. The method of claim 1 wherein the operating costs include energy consumption.

5. The method of claim 1 wherein the operating costs include insurance payments.

6. The method of claim 1 wherein the operating costs include incidental damage repair.

7. The method of claim 1, wherein the operating costs include collision repair.

8. The method of claim 1 wherein the operating costs include governmental fees.

9. The method of claim 1, wherein the method comprises the step of the lessor remotely disabling the vehicle.

10. The method of claim 1, wherein the method comprises the step of the lessor locating the vehicle with a GPS location device.

11. The method of claim 2, wherein the method comprises the step of the lessor performing the routine maintenance.

12. The method of claim 6, wherein the method comprises the step of the lessor performing the incidental damage repair.

13. The method of claim 7, wherein the method comprises the step of the lessor performing the collision repair.

14. The method of claim 1, wherein the vehicle comprises two steerable front wheels and a single rear wheel.

15. The method of claim 14, wherein the vehicle comprises a deformation-resistant roll cage disposed about an enclosed passenger compartment.

16. The method of claim 15, wherein the enclosed passenger compartment comprises a seat that places an operator in a generally recumbent position.

17. The method of claim 1, wherein the vehicle comprises a center of gravity disposed forward of a midpoint of a line joining a front axle and a rear axle.

18. The method of claim 1, wherein the vehicle comprises a center of gravity disposed below a line joining a front axle and a rear axle.

19. The method of claim 14, wherein the vehicle comprises a trailing arm connecting the rear wheel to a frame of the vehicle.

20. The method of claim 14, wherein the vehicle comprises a constantly variable transmission.
